(19) United States
(12) Patent Application Publication
(10) Pub. No.: US 2010/0296440 A1
(43) Pub. Date: Nov. 25, 2010

(54) UNICAST STREAM DISTRIBUTION FOR WIRELESS NETWORKS

(75) Inventors: Ville Vesa Pernu, Tampere (FI); Jussi Tuomas Benjamin Ratilainen, Viiala (FI)

Correspondence Address: BRAKE HUGHES BELLERMANN LLP, c/o CPA Global, P.O. BOX 52050, MINNEAPOLIS, MN, 55402, US

(73) Assignee: Nokia Corporation, Espoo (FI)

(21) Appl. No.: 12/470,579

(22) Filed: May 22, 2009

(51) Int. Cl. H04W 40/00; H04W 76/02

(52) U.S. Cl. 370/328

(57) ABSTRACT

Various example embodiments are disclosed herein. According to an example embodiment, a technique may include establishing, by a primary wireless station, a first wireless connection with a transmitting wireless station; receiving, at the primary wireless station from the transmitting wireless station via the first wireless connection, a unicast data stream that is directed to the primary wireless station; providing data stream identification information from the primary wireless station to a secondary wireless station, the data stream identification information to allow the secondary wireless station to receive the unicast data stream that is directed to the primary wireless station.

### TECHNICAL FIELD

This description relates to wireless networks.

### BACKGROUND

In some cases, multiple wireless devices may be connected to an access point (AP) or a base station (BS) and may receive the same data stream. In some cases, the transmission of multiple duplicate data streams may be an inefficient use of resources.

### SUMMARY

According to an example embodiment, a method may include establishing, by a primary wireless station, a first wireless connection with a transmitting wireless station; receiving, at the primary wireless station from the transmitting wireless station via the first wireless connection, a unicast data stream that is directed to the primary wireless station; providing data stream identification information from the primary wireless station to a secondary wireless station, the data stream identification information to allow the secondary wireless station to receive the unicast data stream that is directed to the primary wireless station.

According to an example embodiment, an apparatus may include means for establishing, by a primary wireless station, a first wireless connection with a base station; means for receiving, at the primary wireless station from the base station via the first wireless connection, a unicast data stream that is directed to the primary wireless station; and means for providing data stream identification information from the primary wireless station to a secondary wireless station, the data stream identification information to allow the secondary wireless station to receive the unicast data stream that is directed to the primary wireless station.

According to an example embodiment, an apparatus may be provided (e.g., at a wireless station) and may include a processor, the apparatus being configured to: establish a first wireless connection with a transmitting wireless station; receive, at the primary wireless station from the transmitting wireless station via the first wireless connection, a unicast data stream that is directed to the primary wireless station; and provide data stream identification information from the primary wireless station to a secondary wireless station, the data stream identification information to allow the secondary wireless station to receive the unicast data stream that is directed to the primary wireless station.

According to an example embodiment, a method may include receiving a data stream identification information at a secondary wireless station from a primary wireless station, the data stream identification information to allow the secondary wireless station to receive a unicast data stream that is directed to the primary wireless station; and receiving the unicast data stream at the secondary wireless station from a transmitting wireless station based on the data stream identification information.

According to an example embodiment, an apparatus may include means for receiving a data stream identification information at a secondary wireless station from a primary wireless station, the data stream identification information to allow the secondary wireless station to receive a unicast data stream that is directed to the primary wireless station; and means for receiving the unicast data stream from a base station based on the data stream identification information.

According to another example embodiment, an apparatus may include a processor, the apparatus being configured to: receive a data stream identification information from a primary wireless station, the data stream identification information to allow the apparatus to receive a unicast data stream that is directed to the primary wireless station; and receive the unicast data stream from a base station based on the data stream identification information.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a diagram illustrating the transmission of multiple duplicate unicast data streams according to an example embodiment.

FIG. 3 is a diagram illustrating operation of unicast stream distribution according to an example embodiment.

FIG. 4 is a flow chart illustrating operation of a wireless (or mobile) station according to an example embodiment.

FIG. 5 is a flow chart illustrating operation of a wireless (or mobile) station according to another example embodiment.

FIG. 6 is a block diagram of a wireless node according to an example embodiment.

### DETAILED DESCRIPTION

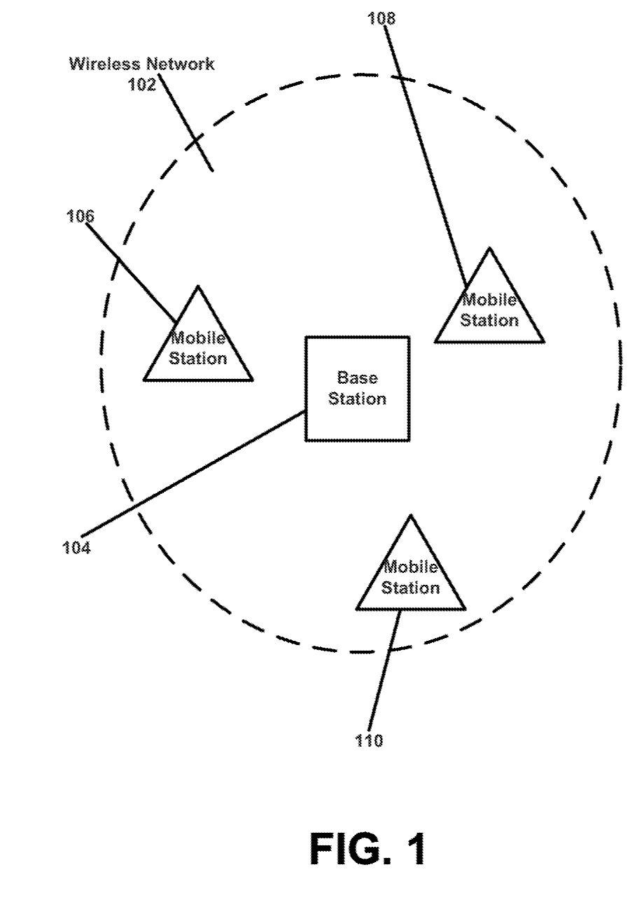

FIG. 1 is a block diagram of a wireless network 102 including a base station (BS) 104 and three (wireless) mobile stations (MSs) 106, 108, 110 according to an example embodiment. Although not shown, mobile stations 106, 108 and 110 may be coupled to base station 104 via relay stations or relay nodes, for example. The wireless network 102 may include, for example, an IEEE 802.16 Wireless Metropolitan Area Network (WiMAX), an IEEE 802.11 Wireless Local Area Network (WLAN), or a cellular telephone network, according to example embodiments, or any other wireless network. The base station (BS) 104 may include a cellular or WiMAX base station (BS), a node B, an 802.11 WLAN access point (AP), or other infrastructure node, according to various example embodiments. The term “base station” (BS) may be used herein and may include any type of infrastructure node. The mobile (or wireless) stations 106, 108, 110 may include IEEE 802.11 WLAN devices, laptop or notebook computers, smartphones, personal digital assistants (PDAs), cellular telephones, WiMAX devices, wireless subscriber stations, or any other wireless device or wireless station, according to example embodiments. The term “wireless node” may include any type of wireless node, such as base stations, mobile stations, etc. While the present disclosure may use some of the terminology of IEEE 802.11 WLAN networks or other wireless standards, aspects of the present disclosure may be applicable to any networking or wireless technologies.

Although not shown in FIG. 1, two (or more) wireless (or mobile) stations may communicate directly with each other, without requiring an infrastructure node (e.g., AP, BS) therebetween. This direct communication between mobile stations may sometimes be referred to as a peer-to-peer communication, or an ad-hoc wireless network, for example. Therefore, the various embodiments and techniques described herein may be applied to mobile stations that communicate with an infrastructure node (e.g., in an infrastructure mode or the like), or directly with another mobile station (e.g., in ad-hoc mode or the like).

Network resources, such as bandwidth, memory, time slots and/or frequency resources, etc., are limited and should be used efficiently where possible. In some cases, multiple wireless devices connected to an access point (AP) or base station (BS) may receive the same data stream, which may be an audio stream (e.g., music or radio program) or a video program, IP (Internet Protocol) TV, or other data stream of interest. For example, multiple wireless devices connected to a BS, may each receive a TV program via the BS. This may result, for example, in duplicate unicast data transmissions along the entire network, e.g., from a wired network to the BS, and then from the BS to each wireless device.

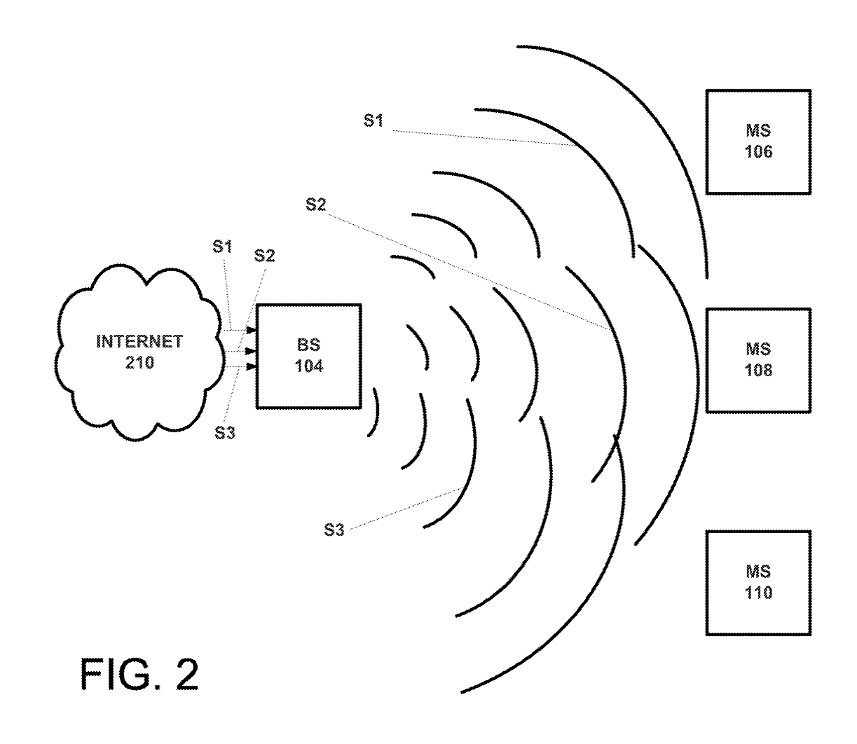

FIG. 2 is a diagram illustrating the transmission of multiple duplicate unicast data streams according to an example embodiment. Each of MSs 106, 108 and 110 may request and receive the same data stream (e.g., same audio or video program or other data stream) from a data source provided within a wired network (such as Internet 210), via BS 104, for example. While Internet 210 is shown as an example of a network that may provide a data stream source, the stream source may be provided from any type of network, such as a private network or Intranet, a home network, a corporate network, the Internet, or other network, as some examples.

In another example embodiment, a primary MS may receive a data stream from a stream source (e.g., via BS 104), and store it locally at the primary MS. The primary MS may then provide stream identification information to one or more secondary MSs. The primary MS may then transmit the stored data stream to the one or more secondary MSs, e.g., via ad-hoc mode.

In an example embodiment, MS 106 may receive a unicast data stream S1, MS 108 may receive a unicast data stream S2 and MS 110 may receive a unicast data stream S3. Unicast data streams S1, S2 and S3 are transmitted from Internet 210 to base station (BS) 104 (for example) via a wired connection or resources, and then transmitted by BS 104 to MS 106, 108 and 110, respectively, via wireless transmission resources. The wireless transmission signals for S1, S2 and S3 are shown between the BS 104 and the MSs to indicate that three separate (duplicate) copies of the data are transmitted, including one unicast data stream S1 directed to MS 106, a unicast data stream S2 directed to MS 108, and a unicast data stream S3 directed to MS 110, as examples. (The wireless transmission signals in FIG. 2 for S1, S2 and S3 are not meant to indicate directional wireless transmissions). FIG. 2 illustrates one technique that allows multiple stations to receive a same data stream according to an example embodiment.

According to another example embodiment, a primary MS (e.g., MS 106) may identify a data stream to be received from a transmitting wireless station. The transmitting wireless station may be, for example, an infrastructure node (e.g., Access Point or AP, Base Station or BS, a Relay Station) or another mobile station (MS) (e.g., a peer MS, or a MS operating in ad-hoc mode). As noted, some examples described herein describe a transmitting wireless station as a BS, but the various techniques may be applied where the transmitting wireless station is a peer MS or wireless station operating in ad-hoc mode or the like. The primary MS may establish a connection with the BS 104 (or other transmitting wireless station) using a temporary address. The primary MS may then receive the data stream as a unicast transmission, e.g., as a unicast data stream, where the unicast data stream is directed to the primary MS, which may include the BS (or other transmitting wireless station) using the temporary MAC address as a destination address for unicast packets of the unicast data stream, or the BS may indicate in the unicast data packets another identifier associated with the primary MS (e.g., stream identifier, connection identifier, mobile station ID or MSID, etc.). Therefore, in an example embodiment, the BS may specify or include information in the data stream packets indicating that the unicast data stream is directed to the primary MS, and the BS does not use a multicast or broadcast address, since this is for a unicast transmission. If the data for the unicast data stream is encrypted, then the primary MS may use a key (e.g., session key) to decrypt the data of the unicast data stream.

The primary MS may then send a message (or messages) to one or more secondary MSs (e.g., MS 108, 110, . . . ) to identify the data stream (e.g., by title, description, by URL or link, or program ID, . . . ) and provide data stream identification information to allow the one or more secondary MSs to detect and/or receive the unicast data stream that is directed to the primary MS. The data stream identification information may include, for example, the temporary MAC address (e.g., used to identify packets for the data stream) and a key which may be used to decrypt the data of the data stream (e.g., in the example where the data may be encrypted). These are just examples of parameters that may be provided as part of data stream identification information, and many other parameters may be provided as part of the data stream identification information to allow secondary MSs to receive the unicast data stream, without the secondary MSs requesting and obtaining their own (e.g., duplicate) unicast data stream transmission directed to the secondary MS. Thus, by the primary MS sharing or providing the data stream identification information to one or more secondary MSs that are within range of a transmitting wireless station that is transmitting the unicast data stream of interest (such as, for example, BS 104), the one or more secondary MSs may also be able to receive the unicast data transmission that is directed to the primary MS. This may allow multiple MSs to receive a same unicast data stream without requiring modifications to the operation of the BS 104, for example. This technique may allow a more efficient use of resources since this technique may avoid the transmission of duplicate copies of the same unicast data stream to each MS, as illustrated in FIG. 2, for example. In an example embodiment, the secondary MSs may detect and receive the unicast data stream directed to the primary MS based on the data stream identification information, e.g., without the secondary MSs connecting to (or associating with) the BS 104 (or other transmitting wireless station) to receive their own copy of the data stream and/or without the knowledge of the BS 104. Further details of various example embodiments will now be described.

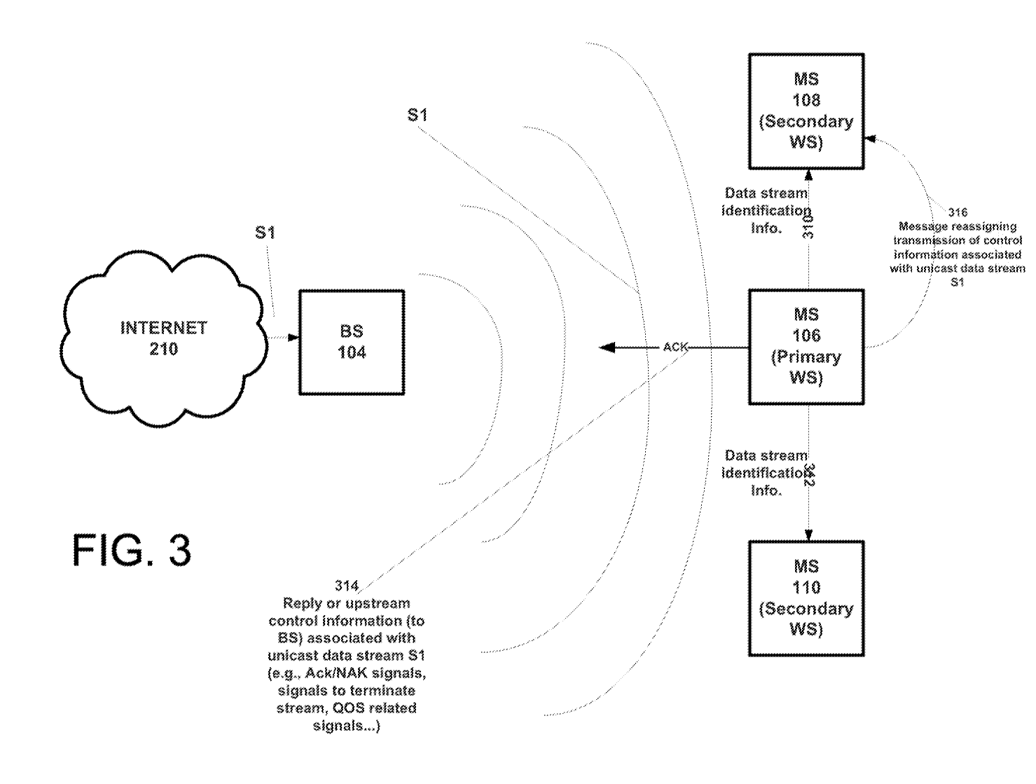

FIG. 3 is a diagram illustrating operation of a system according to an example embodiment. A BS 104 (or AP) may be connected to a wired network, such as the Internet 210 (or other fixed network, for example). BS 104 may also be in wireless communication with one or more mobile (or wireless) stations, or MSs, such as MSs 106, 108 and 110, as examples. In an example embodiment, MSs 106, 108 and 110 may be provided within a local area, e.g., within a building or other geographic area so as to be able to receive signals from the same transmitting wireless station, such as BS 104. In an example embodiment, MS 106 may operate as the primary MS, and the other MSs (108, 110, . . . ) may operate as secondary MSs.

In an example embodiment, a user of MS 106 may have identified a data stream of interest (e.g., audio program, video program, television or IPTV program, or other data stream). The user at MS 106 (or MS 106) may want to share this data stream with the other (e.g., secondary) MSs 108, 110, or allow other MSs to receive this data stream, for example.

In an example embodiment, the primary MS may determine or select a temporary address, such as a temporary MAC (media access control) address, for example. The temporary MAC address may be different from the MAC address that may be permanently associated with hardware (e.g., wireless network interface, wireless transceiver, MAC interface device, or other networking hardware) used by the primary MS. Thus, in an example embodiment, the temporary MAC address may be used to receive and share a unicast data stream, and may not be permanently associated with the primary MS.

In an example embodiment, the primary MS 106 may generate the temporary MAC address or may select the temporary MAC address from a list. In an example embodiment, a system manufacturer (or MS seller/distributor) of MS 106 may reserve a group of MAC addresses for this purpose. The primary MS, in an example embodiment, may randomly select one of these reserved addresses as a temporary MAC address. The primary MS 106 may then confirm that no other MS or device is using this same MAC address. For example, MS 106 may use Inverse Address Resolution Protocol (InARP) to send a message, e.g., to BS 104 or the secondary MSs, to query for the existence of duplicate MAC addresses in the network. For example, this query will fail if another MS or device is already using this same MAC address. In such case, the primary MS may randomly select another temporary MAC address, and may confirm that such address is not being used by other devices or MSs in this network.

In an example embodiment, the primary MS may establish a wireless connection with BS 104 (or other transmitting wireless station) using the temporary MAC address. For example, the primary MS may send an Authentication Request to the BS 104, where the Authentication Request lists the temporary MAC address as the source MAC address. An Authentication Response (or other response message) may be sent from the BS 104 to the primary MS by including the temporary MAC address as the destination MAC address in the Authentication Response. Similarly, the primary MS may associate with the BS 104 using (or based upon) the temporary MAC address, e.g., by sending an Association Request to the BS 104 that includes the temporary MAC address as the source MAC address, for example. The BS 104 may send an Association Response to the primary MS and include the temporary MAC address as the destination MAC address, for example.

Alternatively, rather than using a temporary MAC address, the primary MS may establish a connection using its own MAC address (MAC address permanently assigned to hardware that is used by the primary MS). However, the use of the MS's own or permanently assigned address to receive and share this data stream (share data stream identification information with secondary MSs) may result in sharing or providing this MAC address to other MSs (which may be undesirable), and/or, may prevent the primary MS from receiving other data streams using this MAC address (e.g., the secondary stations may incorrectly attempt to receive another other data stream that uses the same MAC address), at least in some cases.

The use of a temporary MAC address, which is different from the MAC address that may be permanently assigned to hardware used by the primary MS, may have several advantages: 1) by associating or registering with the BS 104 using this temporary MAC address, this MAC address (as part of any stream identification information) may be provided to other/secondary MSs to allow the secondary MSs to detect and/or receive the unicast data stream, without disclosing the MAC address that is permanently assigned to hardware that is used by the primary MS; 2) the primary MS may use different temporary MAC addresses to receive and then share, different data streams with various secondary MSs; and 3) the primary MS may continue to use its own MAC address (assigned to hardware used by the primary MS) for other data streams that are not to be shared or made available to secondary MSs (such as voice connections, email connections, etc.).

Therefore, as noted, according to an example embodiment, the primary MS 106 may establish (or may have already established) a connection with BS 104, which may include, for example, MS 106 performing authentication with BS 104, and performing association with BS 104. The exact operations that may be performed to establish a connection between the MS 106 and BS 104 may vary, depending on the wireless standard or technology. In another example embodiment, the MS 106 establishing a connection with BS 104 may include, for example, performing ranging with BS 104, performing authentication with BS 104, and performing network registration with BS 104. According to an example embodiment, a temporary MAC address (or other temporary address, such as a temporary IP address) may be used to establish the connection between the primary MS 106 and the BS 104.

MS 106 may receive the data stream via the wireless connection established with BS 104. In an example embodiment, MS 106 may receive the data stream as a unicast transmission, e.g., as a unicast data stream, which may be directed to one device or station (e.g., to a unicast address). In an example embodiment, the unicast data stream may include one or more data packets, for example. Each packet transmitted as part of the unicast data stream from the BS to a MS may include a unicast address (e.g., destination address, such as a destination MAC address or destination IP address that identifies or is associated with one MS) or other identifier (e.g., MSID, connection ID, stream ID, or the like) that indicates that the unicast data stream is directed to a particular MS. For example, a BS 104 may assign a MSID to the primary MS for this connection, or may assign a connection ID for this connection, or may assign a stream ID for this data stream, etc.

Referring to FIG. 3, the primary MS 106 may establish a connection with BS 104, e.g., based on the temporary MAC address, and may receive the unicast data stream S1. Data stream S1 is transmitted from Internet to BS 104, and then is transmitted via wireless media from BS 104 to primary MS 106. The primary MS 106 may detect and/or receive packets of the unicast data stream based on, e.g., the temporary MAC address that should be provided in the destination MAC address (or other temporary identifier, for example) of the received data packets. Other identifiers may be used to identify the unicast data stream that is directed to the primary MS 106, such as, MSID, stream ID or connection ID, temporary IP address, etc.

Primary MS 106 may also transmit control information upstream (to BS 104) via line 314 for the unicast data stream, such as acknowledgements that acknowledge receipt of each data packet. For example, MS 106 may receive each packet of the data stream and perform error detection. If a packet(s) was received without error (or without uncorrectable error), MS 106 may send an acknowledgement or ACK to the BS to acknowledge receipt of the data packet of the unicast data stream. The temporary MAC address (used as a destination MAC address for data packets of the data stream) may be used as a source MAC address for the ACKs, for example. Primary MS 106 may also transmit other types of control information relating to the unicast data stream (depending on the technology), such as negative acknowledgements or NAKs that indicate that a packet was not received by the MS, QOS (quality of service) related signals that may request or identify one or more QOS parameters for the MS or for the data stream, e.g., preferred data rate and modulation scheme, and exchange or updating of one or more parameters with the BS 104 (such as a capabilities exchange between the primary MS 106 and BS 104), for example.

The MS 106 may want to share the unicast data stream with other MSs, or allow other (e.g., secondary) MSs, e.g., that are nearby, to receive the unicast data stream. Therefore, primary MS 106 may send a message 310 to secondary MS 108 and a message 312 to secondary MS 110 to describe the unicast data stream, and to provide stream identification information (e.g., which may identify the data stream) to allow the secondary MSs to detect and/or receive the unicast data stream that is directed to the primary MS 106. The stream identification information may include a number of different parameters or information that may allow the secondary MSs to detect and/or receive the unicast data stream, such as the temporary MAC address (which may be provided in a destination MAC address field of each data packet), a MAC address of the transmitting wireless station (e.g., MAC address of BS 104), a key (e.g., a session key) that may be used to decrypt data of the data stream (in the event the data for the data stream is encrypted), etc. Other parameters may be provided, e.g., an IP address associated with the primary MS, an IP address of the transmitting wireless station, an IP address of the data stream source (e.g., IP address of a data server or web server or other data stream source within Internet or network 210), one or more port numbers, such as TCP or UDP port numbers (e.g., which may be provided as source port number and/or destination port number), a MSID (mobile station identifier) associated with or assigned to the primary MS, a connection ID used to identify the connection, a stream ID assigned to the data stream, etc., as examples. The stream identification information may include other types of information that may describe the unicast data stream, such, as media type (e.g., audio, video) of the data stream, format of data, data rate and codec used for transmission, etc. These are merely some examples of the type of information that may be provided as part of the data stream identification information, and other types of information may be included.

As shown in FIG. 3, primary MS 106 may send messages 310 and 312 (which may describe the unicast data stream and/or provide data stream identification information) via the same connection that was established with BS 104, or via a different connection. For example, a same connection may be used by the MS 106 sending messages 310 and 312 via BS 104 to MSs 108 and 110, e.g., via WLAN infrastructure mode via BS 104, and BS 104 may relay or forward such information to the secondary MSs 108, 110. Similarly, if BS 104 is a cellular AP, a same connection or network may be used by MS to communicate the messages 310/312 via SMS (cellular network short message service) messages communicated via BS 104, for example.

Other techniques or applications may be used to send messages 310 and 312 to secondary MSs (these may be considers as being provided over a same connection or a different connection), such as email, web based messaging or chat applications (such as Google Talk, Microsoft Windows Live Messaging, etc.) may be used to provide the data stream identification information to the secondary MSs, for example.

Alternatively a different connection and/or different network may be used by MS 106 to send messages 310 and 312 (providing data stream identification information) to MSs 108 and 110, such as messages sent via a Bluetooth connection, via a WiMAX connection (e.g., via a different BS), or via a WLAN Ad Hoc mode (direct MS to MS communication). Thus, for example, primary MS 106 may establish a connection with a BS of a network of a first type (or via a network compliant with a first wireless standard or first network standard) and may receive the unicast data stream via the network of the first type/first wireless standard; and, the primary MS may provide data stream identification information (or messages 310/312) to secondary MSs via a network of a second type (or via a network that is compliant with a second wireless/network standard). Then, according to an example embodiment, secondary MSs 108, 110 may each then receive the unicast data stream directed to the primary MS 106 via the connection of the first type (or via the network or BS that is compliant with the first wireless or network standard), based on the stream identification information.

To summarize an example of a general operation at secondary MSs, each secondary MS (e.g., 108, 110) may receive a message (e.g., 310, 312) from primary MS 106 that may describe or advertise the unicast data stream that is directed to the primary MS, such as providing a title, description, URL or other information regarding the data stream, and data stream identification information (e.g., one or more of a temporary MAC address or other identifier associated with the primary MS, a MAC address of the transmitting wireless station or BS, a key for decryption, an IP address of the data stream source, an IP address of the transmitting wireless station, port number(s), and the like) that may be used by each secondary MS to detect and/or receive the unicast data stream that is directed to the primary MS 106. The data stream identification information may also include, for example, media type (e.g., audio, video, text), type of codec, or type of coding scheme and modulation scheme used, data rate, QoS information, and other parameters that describe or relate to the transmission of the data stream. Each secondary MS may then receive the unicast data stream that is directed to the primary MS 106 based on the data stream identification information. For example, each secondary MS may detect packets for the stream based on the temporary MAC address being present in a destination MAC address field of each data packet (or other identifier in the packet), and data in the stream may be decrypted based on the key received from the primary MS, as examples. The secondary MSs typically do not send control information to the BS, such as acknowledgments, unless this task has been assigned to the secondary MS, as described in greater detail herein.

In one example embodiment, only one MS may transmit upstream control information to the BS 104 (or other transmitting wireless station) for the unicast data stream, such as ACKs, etc. For example, BS 104 (or other transmitting wireless station) may be expecting only one acknowledgement (ACK) for each transmitted data packet. Moreover, BS 104 is transmitting the unicast data stream to one MS (e.g., the primary MS 106), and may typically be unaware that other/secondary MSs may also be receiving or detecting the data stream. Therefore, performing error detection, transmission of control information (e.g., ACKs, termination of the data stream, or disassociating with the BS 104, etc.) may typically be handled by only one MS, such as the primary MS 106 as a default.

However, in another example embodiment, the primary MS may send a message 316 to one of the secondary MSs (e.g., secondary MS 108) to reassign the transmission of control information for the data stream to the secondary MS. In such case, the primary MS may thereafter discontinue sending control information for the data stream (and may discontinue performing error detection and sending ACKs for each data packet for the unicast data stream directed to the primary MS), and the secondary MS (to which these tasks have now been assigned by primary MS 106) may continue performing these tasks for the unicast data stream (even though the data stream is not directed to the secondary MS).

In sending ACKs, after reassignment of transmission of control information to the secondary MS 108, the secondary MS 108 may then, for example, perform error detection for each packet, send ACKs or other control information for the data stream as needed (and according to the wireless standard or protocol implemented by MS and BS, such as 802.11/WLAN or other protocol), and may send updated QOS parameters, etc., or send other signals to the BS 104. In sending control information for the unicast data stream, the secondary MS 108 in this case may use the temporary MAC address (or other identification information that may be associated with the primary MS 106 for this unicast data stream), such as a mobile station ID or MSID, a stream ID, a connection ID, etc., in messages or packets sent to the BS 104. In this manner, the BS 104 (or other transmitting wireless station) will not necessarily know that these tasks have been handed off to another MS, e.g., since a same temporary MAC address (or other identifier associated with the primary MS for this data stream) may typically be used on the control signals/information transmitted to the BS 104.

The primary MS 106 may send a second message (e.g., a cancel message) to cancel the re-assignment of the transmission of control information, such as acknowledgements, to BS 104 for this unicast data stream. Upon receipt of the cancel message, the secondary MS 108 may then discontinue performing tasks that were re-assigned to it for this data stream, and the primary MS 106 may resume performing these tasks, such as, for example, performing error detection and sending acknowledgements to BS 104, etc.

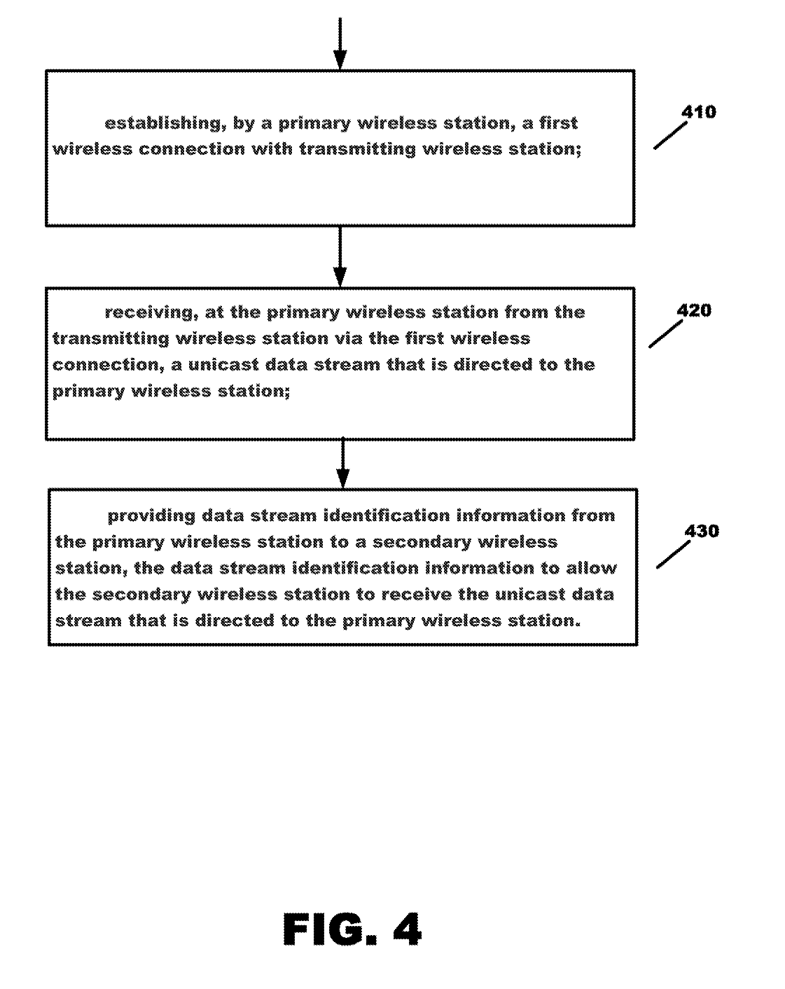

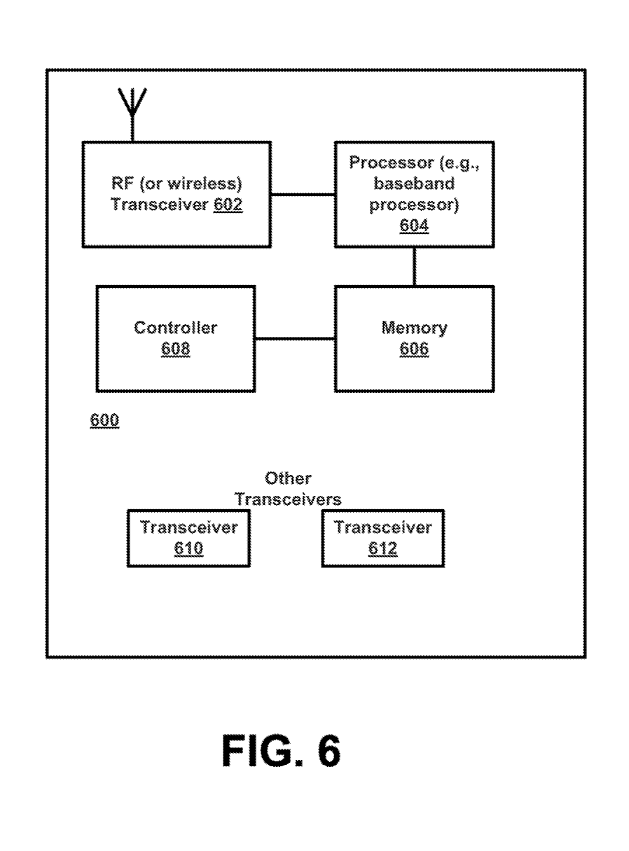

FIG. 4 is a flow chart illustrating operation of a wireless (or mobile) station according to an example embodiment. Also, the reference numbers in the series 6xx refer to blocks shown in FIG. 6 and described in greater detail below.

Referring to FIG. 4, operation 410 may include establishing (e.g., by processor 604 and/or transceiver 602, shown in FIG. 6) by a primary wireless station, a first wireless connection with a transmitting wireless station. The transmitting wireless station, for example, may be transmitting a data stream of interest. The transmitting wireless station may be, for example, an infrastructure node, such as an access point (AP), base station (BS), relay station, or the like. Or, the transmitting wireless station may be a non-infrastructure node, such as another mobile station, which may be transmitting in ad-hoc (peer-to-peer) mode, for example.

Operation 420 includes receiving (e.g., by processor 604 and/or transceiver 602, FIG. 6), at the primary wireless station from the transmitting wireless station via the first wireless connection, a unicast data stream that is directed to the primary wireless station.

Operation 430 includes providing (e.g., by processor 604 and/or transceiver 602, FIG. 6) data stream identification information from the primary wireless station to a secondary wireless station, the data stream identification information to allow the secondary wireless station to receive the unicast data stream that is directed to the primary wireless station.

In an example embodiment, the establishing operation 410 may include the primary wireless station performing the following: performing authentication with the transmitting wireless station; and, performing association with the transmitting wireless station, wherein the transmitting wireless station is an IEEE 802.11 access point.

In the flow chart of FIG. 4, the providing operation 430 may include the primary wireless station providing one or more of the following to the secondary wireless station to allow the secondary wireless station to detect and/or receive the unicast data stream from the transmitting wireless station that is directed to the primary wireless station: an address associated with the primary wireless station; and a key to be used for decrypting data of the unicast data stream.

The providing operation 430 may include the primary wireless station providing the following to the secondary wireless station to allow the secondary wireless station to detect and/or receive the unicast data stream from the base station that is directed to the primary wireless station: a temporary MAC (Media Access Control) address temporarily associated with the primary wireless station; and a key to be used for decrypting data of the unicast data stream.

The providing operation 430 may include providing data stream identification information from the primary wireless station to a secondary wireless station via a second wireless connection, the data stream identification information to allow the secondary wireless station to receive the unicast data stream that is directed to the primary wireless station.

The providing operation 430 may include the primary wireless station providing the following to the secondary wireless station to allow the secondary wireless station to detect and/or receive the unicast data stream from the transmitting wireless station that is directed to the primary wireless station: an identifier associated with the primary wireless station or the data stream, including one or more of a MAC (Media Access Control) address associated with the primary wireless station, a MAC address associated with the transmitting wireless station, IP (Internet Protocol) address associated with the primary wireless station, an IP address associated with the transmitting wireless station, one or more port numbers, a station ID that identifies the primary wireless station, a connection ID that identifies a connection for the unicast data stream, a stream ID that identifies the unicast data stream.

The flow chart of FIG. 4 may further include the primary wireless station performing the following: determining (e.g., by processor 604) a temporary address that is different from an address assigned to the primary wireless station; providing the temporary address to the transmitting wireless station; and receiving (e.g., by processor 604 and/or transceiver 602) one or more data packets of the unicast data stream from the transmitting wireless station, the one or more data packets of the unicast data stream being addressed to the temporary address; wherein the providing data stream identification information may include the primary wireless station providing (e.g., by processor 604 and/or transceiver 602) at least the temporary address to the secondary wireless station to allow the secondary wireless station to detect and/or receive packets of the unicast data stream.

In an example embodiment, the determining a temporary address may include determining (by processor 604) a temporary MAC (media access control) address to be temporarily used to receive the unicast data stream, the temporary MAC address being different from a permanent MAC address that has been assigned to hardware associated with the primary wireless station.

In an example embodiment, the determining a temporary MAC address may include: selecting (e.g., by processor 604) a temporary MAC (media access control) address from a list of addresses; and confirming (e.g., by processor 604) that the selected temporary MAC address is unused at the transmitting wireless station.

The providing operation 430 may include providing the data stream identification information from the primary wireless station to each of a plurality of secondary wireless stations.

The method of FIG. 4, wherein only the primary wireless station is sending acknowledgements to the transmitting wireless station to acknowledge receipt of packets of the unicast data stream from the transmitting wireless station.

The method of FIG. 4, and further comprising only one of the primary wireless station and secondary wireless station sending acknowledgements to the transmitting wireless station to acknowledge receipt of packets of the unicast data stream from the transmitting wireless station, the method further including: the primary wireless station initially sending acknowledgements; and the primary wireless station sending a message to the secondary wireless station reassigning the sending of acknowledgements from the primary wireless station to the secondary wireless station.

In an example embodiment, the receiving operation 420 may include receiving, at the primary wireless station from the transmitting wireless station via the first wireless connection provided via a wireless network compliant with a first wireless standard, a unicast data stream that is directed to the primary wireless station; and the providing operation 430 may include providing data stream identification information from the primary wireless station to a secondary wireless station via a second wireless connection via a wireless network compliant with a second wireless standard.

According to an example embodiment, an apparatus may include means (e.g., processor 604 and/or transceiver 602) for establishing, by a primary wireless station, a first wireless connection with a transmitting wireless station (e.g., a BS or other wireless station); means (e.g., processor 604 and/or transceiver 602) for receiving, at the primary wireless station from the transmitting wireless station via the first wireless connection, a unicast data stream that is directed to the primary wireless station; and, means (e.g., processor 604 and/or transceiver 602) for providing data stream identification information from the primary wireless station to a secondary wireless station, the data stream identification information to allow the secondary wireless station to receive the unicast data stream that is directed to the primary wireless station.

In an example embodiment, the means for providing the data stream identification information may include means (e.g., processor 604 and/or transceiver 602) for providing the following from the primary wireless station to the secondary wireless station to allow the secondary wireless station to detect and/or receive the unicast data stream from the transmitting wireless station that is directed to the primary wireless station: an address associated with the primary wireless station; and a key to be used for decrypting data of the unicast data stream.

According to an example embodiment, an apparatus provided at a wireless station and may include a processor, the apparatus being configured to: establish (e.g., by processor 604 and/or transceiver 602), e.g., by a primary wireless station, a first wireless connection with a transmitting wireless station; receive (e.g., processor 604 and/or transceiver 602), e.g., at the primary wireless station from the transmitting wireless station via the first wireless connection, a unicast data stream that is directed to the primary wireless station; and provide (e.g., processor 604 and/or transceiver 602) data stream identification information to a secondary wireless station, the data stream identification information to allow the secondary wireless station to receive the unicast data stream that is directed to the primary wireless station.

In an example embodiment, the apparatus being configured to provide the data stream identification information may include the apparatus being configured to provide the following, from the primary wireless station to the secondary wireless station, to allow the secondary wireless station to detect and/or receive the unicast data stream from the transmitting wireless station that is directed to the primary wireless station: a temporary MAC (media access control) address temporarily associated with the primary wireless station; and a key to be used for decrypting data of the unicast data stream.

In an example embodiment, the apparatus being configured to determine a temporary address may include the apparatus being configured to determine a temporary MAC address to be temporarily used to receive the unicast data stream, the temporary MAC address being different from a permanent MAC address that has been assigned to hardware associated with the primary wireless station.

In an example embodiment, the apparatus may be provided at the primary wireless station, and wherein only one of the primary wireless station and the secondary wireless station are configured to send acknowledgements to the transmitting wireless station to acknowledge receipt of packets of the unicast data stream from the transmitting wireless station; the primary wireless station being further configured to send a message to the secondary wireless station reassigning the sending of the acknowledgements from the primary wireless station to the secondary wireless station, and the primary wireless station discontinuing sending of the acknowledgements for received data packets after the reassigning.

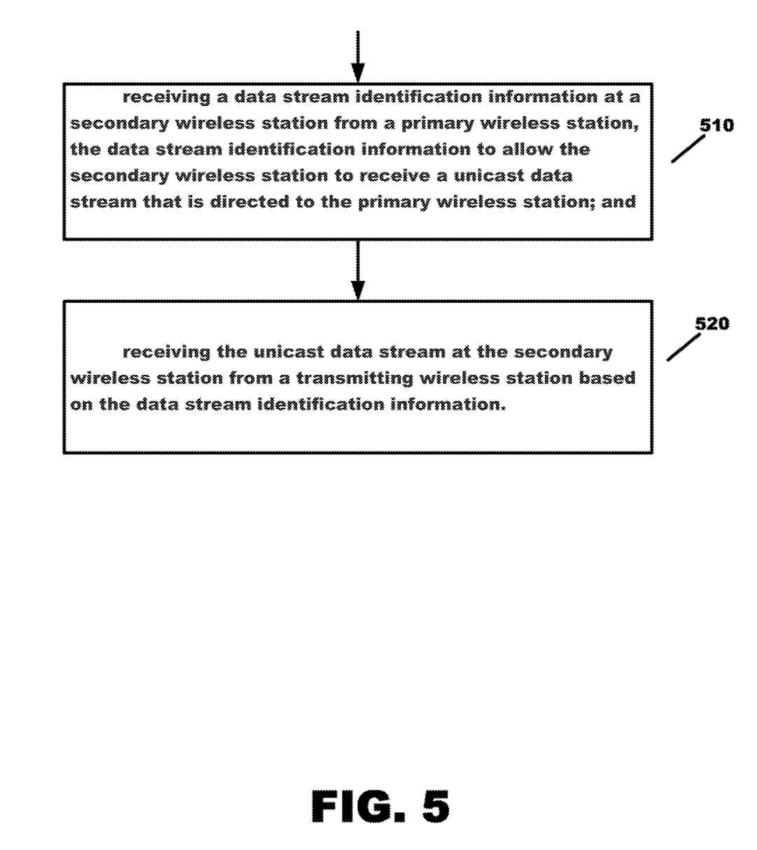

FIG. 5 is a flow chart illustrating operation of a wireless (or mobile) station according to another example embodiment. Operation 510 may include receiving (e.g., by processor 604 and/or transceiver 602) a data stream identification information at a secondary wireless station from a primary wireless station, the data stream identification information to allow the secondary wireless station to receive a unicast data stream that is directed to the primary wireless station; and receiving (e.g., by processor 604 and/or transceiver 602) the unicast data stream at the secondary wireless station from a transmitting wireless station based on the data stream identification information.

According to another example embodiment, an apparatus may include: means (e.g., by processor 604 and/or transceiver 602) for receiving a data stream identification information at a secondary wireless station from a primary wireless station, the data stream identification information to allow the secondary wireless station to receive a unicast data stream that is directed to the primary wireless station; and means (e.g., by processor 604 and/or transceiver 602) for receiving the unicast data stream from a transmitting wireless station based on the data stream identification information.

According to another example embodiment, an apparatus may be provided in a secondary wireless station, the apparatus may include a processor (e.g., processor 604), the apparatus (e.g., the processor) being configured to: receive a data stream identification information at a secondary wireless station from a primary wireless station, the data stream identification information to allow the secondary wireless station to receive a unicast data stream that is directed to the primary wireless station; and receive the unicast data stream from a transmitting wireless station based on the data stream identification information.

In an example embodiment of the apparatus, the data stream identification information may include: an address associated with the primary wireless station; and a key to be used for decrypting data of the unicast data stream.

In an example embodiment of the apparatus, the apparatus being configured to receive may include the apparatus being configured to perform the following: detect (e.g., by processor 604 and/or transceiver 602) and receive one or more data packets associated with the unicast data stream directed to the primary mobile station based on the address associated with the primary wireless station; and decrypt (e.g., by processor 604) data within the one or more received data packets based on the key.

In an example embodiment of the apparatus, the data stream identification information may include a MAC (media access control) address that is temporarily associated with the primary wireless station.

In an example embodiment of the apparatus, the apparatus at the secondary wireless station may be further configured to receive a message from the primary wireless station reassigning, from the primary wireless station to the secondary wireless station, a sending of acknowledgements (or other control information) to the transmitting wireless station to acknowledge receipt of packets of the unicast data stream from the transmitting wireless station.

In an example embodiment of the apparatus, wherein the data stream identification information may include an address that is temporarily associated with the primary wireless station, the apparatus at the secondary wireless station being further configured to send, based on the received message, acknowledgements to the transmitting wireless station to acknowledge receipt of one or more packets of the unicast data stream that is directed to the primary wireless station from the transmitting wireless station, the acknowledgements sent by the secondary wireless station including the address that is temporarily associated with the primary wireless station.

FIG. 6 is a block diagram of a wireless station (or wireless node) 600 according to an example embodiment. The wireless station 600 (e.g., base station 104 or mobile station 106, 108 or 110) may include, for example, an RF (radio frequency) or wireless transceiver 602, including a transmitter to transmit signals and a receiver to receive signals, a processor 604 to execute instructions or software and control transmission and receptions of signals, and a memory 606 to store data and/or instructions.

Processor 604 may also make decisions or determinations, generate frames or messages for transmission, decode received frames or messages for further processing, and other tasks or functions described herein. Processor 604, which may be a baseband processor, for example, may generate messages, packets, frames or other signals for transmission via wireless transceiver 602. Processor 604 may control transmission of signals or messages over a wireless network, and may receive signals or messages, etc., via a wireless network (e.g., after being down-converted by wireless transceiver 602, for example). Processor 604 may be programmable and capable of executing software or other instructions stored in memory or on other computer media to perform the various tasks and functions described above, such as one or more of the tasks or methods described above. Processor 604 may be (or may include), for example, hardware, programmable logic, a programmable processor that executes software or firmware, and/or any combination of these. Using other terminology, processor 604 and transceiver 602 together may be considered as a wireless transmitter/receiver system, for example.

In addition, referring to FIG. 6, a controller (or processor) 608 may execute software and instructions, and may provide overall control for the station 600, and may provide control for other systems not shown in FIG. 6, such as controlling input/output devices (e.g., display, keypad), and/or may execute software for one or more applications that may be provided on wireless station 600, such as, for example, an email program, audio/video applications, a word processor, a Voice over IP application, or other application or software.

In addition, the apparatus at the wireless station 600 may include one or more additional wireless transceivers 610, 612 (e.g., each including both MAC and PHY or physical interface), e.g., such as a cellular (e.g., GSM) transceiver, WiMAX transceiver, Bluetooth transceiver, etc., for example, if the transceiver 602 is a WLAN transceiver, as an example. This may allow, for example, a MS (e.g., 106) to communicate and establish a connection with a BS via a first wireless network (e.g., compliant with a first wireless standard) using a first wireless transceiver, and then provide or communicate the data stream identification information to one or more secondary MSs via a second wireless network (e.g., using the second wireless transceiver).

In addition, a storage medium may be provided that includes stored instructions, which when executed by a controller or processor may result in the processor 604, or other controller or processor, performing one or more of the functions or tasks described herein.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
establishing, by a primary wireless station, a first wireless connection with a transmitting wireless station;
receiving, at the primary wireless station from the transmitting wireless station via the first wireless connection, a unicast data stream that is directed to the primary wireless station;
providing data stream identification information from the primary wireless station to a secondary wireless station, the data stream identification information to allow the secondary wireless station to receive the unicast data stream that is directed to the primary wireless station.

2. The method of claim 1 wherein the establishing comprises the primary wireless station performing the following:
performing authentication with the transmitting wireless station;
performing association with the transmitting wireless station, wherein the transmitting wireless station is an IEEE 802.11 access point.

3. The method of claim 1 wherein the providing data stream identification information comprises the primary wireless station providing the following to the secondary wireless station to allow the secondary wireless station to detect and/or receive the unicast data stream from the transmitting wireless station that is directed to the primary wireless station:
a temporary MAC (Media Access Control) address temporarily associated with the primary wireless station; and
a key to be used for decrypting data of the unicast data stream.

4. The method of claim 1 wherein the providing comprises providing data stream identification information from the primary wireless station to a secondary wireless station via a second wireless connection, the data stream identification information to allow the secondary wireless station to receive the unicast data stream that is directed to the primary wireless station.

5. The method of claim 1 wherein the providing data stream identification information comprises the primary wireless station providing the following to the secondary wireless station to allow the secondary wireless station to detect and/or receive the unicast data stream from the base station that is directed to the primary wireless station:
an identifier associated with the primary wireless station or the data stream, including one or more of a MAC (Media Access Control) address associated with the primary wireless station, a MAC address associated with the transmitting wireless station, IP (Internet Protocol) address associated with the primary wireless station, an IP address associated with the transmitting wireless station, one or more port numbers, a station ID that identifies the primary wireless station, a connection ID that identifies a connection for the unicast data stream, a stream ID that identifies the unicast data stream.

6. The method of claim 1 and further comprising the primary wireless station performing the following:
determining a temporary address that is different from an address assigned to the primary wireless station;
providing the temporary address to the transmitting wireless station, the transmitting wireless station comprising a base station or other infrastructure node; and
receiving one or more data packets of the unicast data stream from the transmitting wireless station, the one or more data packets of the unicast data stream being addressed to the temporary address;
wherein the providing data stream identification information comprises the primary wireless station providing at least the temporary address to the secondary wireless station to allow the secondary wireless station to detect and/or receive packets of the unicast data stream.

7. The method of claim 6 wherein the determining a temporary address comprises determining a temporary MAC (media access control) address to be temporarily used to receive the unicast data stream, the temporary MAC address being different from a permanent MAC address that has been assigned to hardware associated with the primary wireless station.

8. The method of claim 1 and further comprising only the primary wireless station sending acknowledgements to the transmitting wireless station to acknowledge receipt of packets of the unicast data stream from the base station.

9. The method of claim 1 and further comprising only one of the primary wireless station and secondary wireless station sending acknowledgements to the transmitting wireless station to acknowledge receipt of packets of the unicast data stream from the transmitting wireless station, the method further comprising:
the primary wireless station initially sending acknowledgements; and
the primary wireless station sending a message to the secondary wireless station reassigning the sending of acknowledgements from the primary wireless station to the secondary wireless station.

10. An apparatus comprising a processor, the apparatus being configured to:
establish a first wireless connection with a transmitting wireless station;
receive, from the transmitting wireless station via the first wireless connection, a unicast data stream that is directed to a primary wireless station; and
provide data stream identification information to a secondary wireless station, the data stream identification information to allow the secondary wireless station to receive the unicast data stream that is directed to the primary wireless station.

11. The apparatus of claim 10 wherein the apparatus being configured to provide the data stream identification information comprises the apparatus being configured to provide the following, from the primary wireless station to the secondary wireless station, to allow the secondary wireless station to detect and/or receive the unicast data stream from the transmitting wireless station that is directed to the primary wireless station:
a temporary MAC (media access control) address temporarily associated with the primary wireless station; and
a key to be used for decrypting data of the unicast data stream.

12. The apparatus of claim 10 wherein the transmitting wireless station comprises a base station or other infrastructure node, and further wherein the apparatus being configured to determine a temporary address comprises the apparatus being configured to determine a temporary MAC address to be temporarily used to receive the unicast data stream, the temporary MAC address being different from a permanent MAC address that has been assigned to hardware associated with the primary wireless station.

13. The apparatus of claim 10, wherein the apparatus is provided at the primary wireless station, and wherein only one of the primary wireless station and the secondary wireless station are configured to send acknowledgements to the transmitting wireless station to acknowledge receipt of packets of the unicast data stream from the transmitting wireless station;
the primary wireless station being further configured to send a message to the secondary wireless station reassigning the sending of the acknowledgements from the primary wireless station to the secondary wireless station, and the primary wireless station discontinuing sending of the acknowledgements for received data packets after the reassigning.

14. A method comprising:
receiving a data stream identification information at a secondary wireless station from a primary wireless station, the data stream identification information to allow the secondary wireless station to receive a unicast data stream that is directed to the primary wireless station; and
receiving the unicast data stream at the secondary wireless station from a base station based on the data stream identification information.

15. An apparatus comprising a processor, the apparatus being configured to:
receive a data stream identification information from a primary wireless station, the data stream identification information to allow the apparatus to receive a unicast data stream that is directed to the primary wireless station; and
receive the unicast data stream from a transmitting wireless station based on the data stream identification information.

16. The apparatus of claim 15 wherein the data stream identification information comprises: an address associated with the primary wireless station; and a key to be used for decrypting data of the unicast data stream, and wherein the transmitting wireless station comprises a base station or other infrastructure node.

17. The apparatus of claim 16 wherein the apparatus being configured to receive comprises the apparatus being configured to perform the following:
detect and receive one or more data packets associated with the unicast data stream directed to the primary mobile station based on the address associated with the primary wireless station; and
decrypt data within the one or more received data packets based on the key.

18. The apparatus of claim 15 wherein the data stream identification information comprises a MAC (media access control) address that is temporarily associated with the primary wireless station.

19. The apparatus of claim 15, wherein the apparatus is provided at a secondary wireless station, the apparatus being further configured to receive a message from the primary wireless station reassigning, from the primary wireless station to the secondary wireless station, a sending of acknowledgements to the transmitting wireless station to acknowledge receipt of packets of the unicast data stream from the base station, the transmitting wireless station comprising a base station or other infrastructure node.

20. The apparatus of claim 19 wherein the data stream identification information comprises an address that is temporarily associated with the primary wireless station, the apparatus being further configured to send, based on the received message, acknowledgements to the transmitting wireless station to acknowledge receipt of one or more packets of the unicast data stream that is directed to the primary wireless station from the transmitting wireless station, the acknowledgements sent to the transmitting wireless station including the address that is temporarily associated with the primary wireless station.
